(19) United States
(12) Patent Application Publication
(10) Pub. No.: US 2007/0014301 A1
(43) Pub. Date: Jan. 18, 2007

(54) Method and apparatus for providing static addressing

(75) Inventors: Lawrence F. Miller, Lake Bluff, IL (US); Paul G. Bishop, Hawthorn Woods, IL (US)

Correspondence Address: MCANDREWS HELD & MALLOY, LTD, 500 WEST MADISON STREET, SUITE 3400, CHICAGO, IL, 60661, US

(73) Assignee: Motient Corporation

(21) Appl. No.: 11/235,436

(22) Filed: Sep. 26, 2005

Related U.S. Application Data
(60) Provisional application No. 60/698,739, filed on Jul. 13, 2005.

(51) Int. Cl. H04L 12/56

(52) U.S. Cl. 370/401

(57) ABSTRACT

Certain embodiments of the present invention provide a method and system for improved static address translation. Certain embodiments include a method for address translation in a network, wherein the network includes a device associated with an identifier and assigned a dynamic address. The method includes matching the identifier for the device to a static address; creating an address mapping between the dynamic address assigned to the device and the static address; and transmitting data to and from the device using the address mapping. The method may also include transmitting a record indicating a presence of the device on the network, wherein the record includes the identifier for the device. Additionally, the method may include providing the address mapping to a router for routing data between the device and another entity. The method may automatically create the address mapping between the dynamic address and the static address, for example.

### RELATED APPLICATIONS

The present application relates to, and claims priority from, U.S. Provisional Application No. 60/698,739 filed on Jul. 13, 2005, and entitled “Method and Apparatus for Providing Static Addressing” (Attorney Docket Number 16805US01).

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to device addressing. In particular, the present invention relates to mapping a static address to a dynamic address for device addressing.

Mobile data networks may be classified into two major categories: circuit switched and packet switched. In circuit switched networks, an end-to-end “physical” connection is set up for the duration of a call, and physical assets of the network are dedicated to the particular call for its duration. This does not preclude the case of call hand off, as performed in cellular networks, where the physical path may be switched during the call.

In packet data networks, an end-to-end connection is also set up for the duration of the call, but the connection is “logical”, not physical. A logical connection merely establishes a routing of packets through a multiplicity of switching nodes within the network, the path being determined by source and destination addresses of the packets. It is not necessary to dedicate to the call a specific physical path for the entire call duration; packets with different source and destination addresses, following different logical paths, are time multiplexed on links within the network.

Traditionally, a mobile device is assigned a dynamic address by the mobile carrier each time the device begins a communication session. Due to a large number of mobile devices in use and a cost associated with assigning static addresses, mobile carriers do not want to assign a permanent, static address to a mobile device. Use of a frequently-changing dynamic address may not pose a problem if the mobile device initiates a conversation with another entity (e.g. fetch a page from a web site). Dynamic addressing becomes problematic, however, when other entities wish to start a conversation with the mobile device because the device's current dynamic address is unknown to the other entities.

Currently, mobile carriers may execute a domain name system (DNS) lookup on an identifier provided in-band or over the air by the mobile device to map a dynamic address for the mobile device. Alternatively, a dedicated computer may read packets received from a mobile device with a dynamic address on a network. The computer internally translates the dynamic address and then routes the packets to a static port. A host device responds to the packets from the mobile device by sending packets to a fixed address associated with the dedicated computer. The computer then internally looks up the proper dynamic address for the mobile device.

However, current methods of address translation lack flexibility to accommodate data transmitted from a plurality of mobile devices and a plurality of other entities, such as host computers or other systems. Current methods and systems rely on information communicated in-band or over the air by the mobile device to perform address mapping. Use of information communicated by the device itself adds complexity and time to information routing and connectivity with mobile devices. Therefore, a system and method using out-of-band information for address mapping at the network later would be highly desirable. A system and method facilitating dynamic-to-static address mapping without reliance on information from the mobile device would be highly desirable.

Additionally, traditional multi-vendor network operators allow customers to communicate with devices spanning multiple networks. However, each carrier's dynamic address pool is different, thus complicating multiple network routing. Currently, carrier address pools are not translated and must be exposed directly to customers. Customers must allow multiple routes to accommodate the various carrier pools. Therefore, a system and method providing address translation and improved routing would be highly desirable.

Furthermore, carriers mix traffic for many multi-vendor network operators within the same address range. That is, a pool of dynamic addresses may be shared by all of a carrier's network operators on the same high availability network. Thus, multi-vendor network operators on the same network may send traffic to each other's devices. Therefore, a system and method providing additional security in customer communications and address allocation would be highly desirable.

Thus, there is a need for a system and method for improved static addressing for mobile devices.

### BRIEF SUMMARY OF THE INVENTION

Certain embodiments of the present invention provide a method and system for improved static address translation. Certain embodiments include a method for address translation in a mobile network, wherein the network includes a device associated with an identifier and assigned a dynamic address. The method includes matching the identifier for the device to a static address; creating an address mapping between the dynamic address assigned to the device and the static address; and transmitting data to and from the device using the address mapping. The method may also include transmitting a record indicating a presence of the device on the network, wherein the record includes the identifier for the device. Additionally, the method may include providing the address mapping to a router for routing data between the device and another entity. In an embodiment, the method may automatically create the address mapping between the dynamic address and the static address, for example. In an embodiment, the static address is a known address assigned to the device. In an embodiment, a pool of static addresses may be allocated to a carrier for mapping dynamic address for devices from the carrier to static address from the pool of static addresses. The method may also include seeding a domain name system using the address mapping. In an embodiment, the device may be activated or “woken up” in response to data being transmitted to the device using the address mapping, for example.

Certain embodiments include a system for address mapping in a network. The system includes a dynamic network address (DNA) server and a router for routing data in the network. The DNA server is configured to map a dynamic address to a static address based on a device identifier associated with the dynamic address. The router is configured to route data in the network using the mapping between the static address and the dynamic address. The system may also include a recording including the device identifier and the dynamic address associated with the device identifier, for example. The system may further include a database storing the record. In an embodiment, the system includes a domain name system (DNS) providing address mapping for one or more devices. The DNS is seeded using the mapping between the static address and the dynamic address, for example. Furthermore, the system may include a route injector configured to establish a subnet and address based on the mapping to received data from an external system.

In an embodiment, the router includes a network address translation (NAT) mapping the dynamic address to the static address for the device identifier. The router may also include an access control list (ACL) to regulate traffic for a range of static addresses. In an embodiment, the DNA server allocates a block of static addresses to a carrier for mapping dynamic addresses for devices from the carrier to static addresses from the block of static addresses.

Certain embodiments include an electronically-readable storage medium including a set of instructions for a processor. The set of instructions includes an accounting routine, a mapping routine, and a routing routine. The accounting routine receives an accounting record for a device, wherein the accounting record includes a dynamic address allocated to the device. The mapping routine maps the dynamic address to a static address assigned to the device. The routing routine routes data to and from the device using the address mapping.

In an embodiment, the mapping routine automatically maps the dynamic address to the static address assigned to the device upon receipt of the accounting record and the routing routine automatically routes data to and from the device using the address mapping. In an embodiment, the mapping routine matches a device identifier associated with the device to a corresponding static address assigned to the device and maps the dynamic address to the static address. In an embodiment, the routing routine regulates data transmitted to and from the device using the address mapping based on a criterion, such as an authorization, a device activation, an address range, etc. In an embodiment, the dynamic address is a dynamic Internet protocol (IP) address, for example.

Additionally, certain embodiments provide a device that includes an electronically-readable storage medium having a set of instructions for execution on a processor. The set of instructions includes an accounting routine, a mapping routine, and a routing routine. The accounting routine receives an accounting record for a device, wherein the accounting record includes a dynamic address allocated to the device. The mapping routine maps the dynamic address to a static address assigned to the device. The routing routine routes data to and from the device using the address mapping. In an embodiment, the mapping routine matches a device identifier associated with the device to a corresponding static address assigned to the device and maps the dynamic address to the static address.

### BRIEF DESCRIPTION OF SEVERAL VIEWS OF THE DRAWINGS

FIG. 1 illustrates a communication system providing address mapping in accordance with an embodiment of the present invention.

FIG. 2 illustrates a network infrastructure system used in accordance with an embodiment of the present invention.

FIG. 3 illustrates a DNA service architecture used in accordance with an embodiment of the present invention.

FIG. 4 illustrates an access radius operation forwarding system used in accordance with an embodiment of the present invention.

FIG. 5 illustrates an access listener system used in accordance with an embodiment of the present invention.

FIG. 6 illustrates a DNS manager system used in accordance with an embodiment of the present invention.

FIG. 7 illustrates a NAT master system used in accordance with an embodiment of the present invention.

FIG. 8 depicts a flow diagram for a method for dynamic network architecture used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

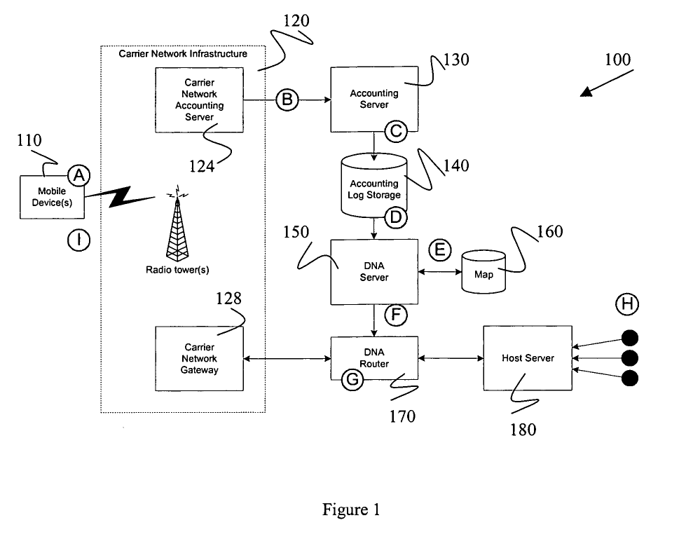

FIG. 1 illustrates a communication system 100 providing addressing mapping in accordance with an embodiment of the present invention. The system 100 includes a mobile device 110, a carrier network infrastructure 120 including a carrier network accounting server 124 and a carrier network gateway 128, an accounting server 130, an accounting log storage 140, a dynamic network architecture (DNA) server 150, a map table 160, a DNA router 170, and a host server 180. The components of the system 100 may be implemented in software, hardware and/or firmware, for example. The components of the system 100 may be implemented separately and/or combined in various forms. The components of the system 100 may communicate via wired and/or wireless communication, for example. The system 100 may operate in conjunction with one or more networks including terrestrial networks, satellite networks, etc.

In an embodiment, the mobile device 110 initiates a session with the carrier network infrastructure 120 of a mobile carrier. The carrier infrastructure 120 (for example, the carrier network accounting server 124) sends an accounting ‘Start’ record including the mobile device's station identification (Station Id) number and dynamic Internet Protocol (IP) address, for example. The infrastructure 120 may transmit a plurality of records, such as start, stop, and update (e.g., periodic or scheduled status/activity update) records. The accounting server 130 accepts the record for the mobile device 110 and stores the start record in a database, such as the accounting log storage 140. Alternatively, the mobile device 110 record may be used without being stored. A trigger or other function associated with the database 140 forwards the device's Station Id and Dynamic Address to the DNA server 150.

The DNA server 150 looks up a static address that is associated with the Station Id. For example, the DNA server 150 queries the map table 160 to determine one or more static addresses associated with the Station Id. The DNA server 150 forwards a copy of the dynamic address and static address for the device 110 to the DNA router 170.

The DNA router 170 adds a Network Address Translation (NAT) to map the dynamic address to the proper static address for the device 110. Host connections may now access the device 110 via the well-known static IP address which is mapped to the dynamic address. The DNA router 170 performs network address translation on traffic from the host server 180 or other external system and sends data to the carrier 120 for delivery to the device 110. Packets sent by the device 110 are translated by the router 170 and sent to the host 180.

The improved Dynamic Network Architecture (DNA) system automatically manages routing for wireless devices operating in a wireless carrier network environment. The DNA system, such as the system 100, works with an access or AAA (authentication, authorization and accounting) server and DNA-enabled routers to provide a robust, cost-effective solution for static addressing. Name-resolution services may also be performed in conjunction with the DNA system. The DNA system may use the AAA information to seed a Domain Name System (DNS), for example. The DNS provides address mapping so customers can access their devices via an alternate identifier (e.g. electronic serial number or “ESN”).

In an embodiment, the DNS is an ancillary service that may be seeded by the DNA system during NAT processing. The DNA system has a carrier's device identifier and may map the identifier to an appropriate IP address for the DNS. Even if no static NAT entry is present in a translation map, the DNA may add a DNS entry to identify the device by its dynamic address. The DNA system may also fetch a tertiary identifier (e.g., ESN, customer identifier, etc.) from a map and insert a special entry into the DNS, for example.

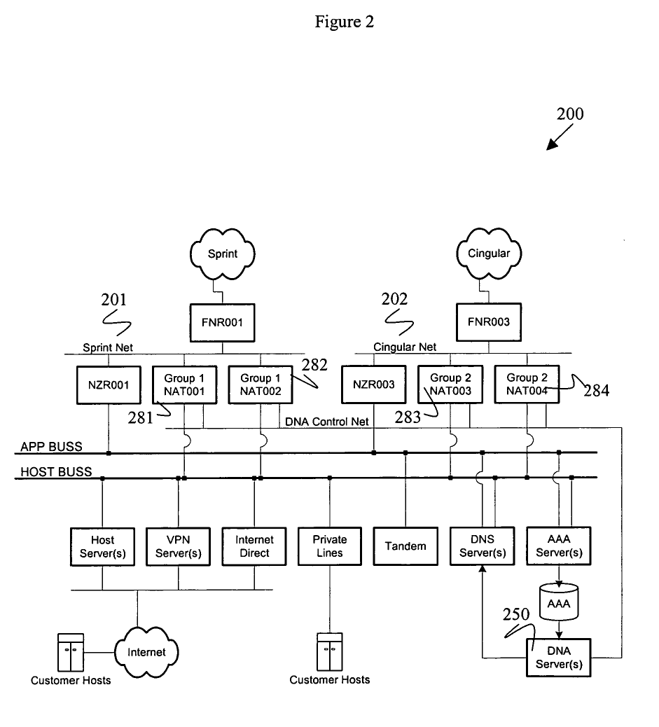

FIG. 2 illustrates a network infrastructure system 200 used in accordance with an embodiment of the present invention. As shown in FIG. 2, special NAT routers 281-284 are controlled by the DNA server 250 to map dynamic device addresses from carrier networks 201-202 to specific, controllable addresses in the network infrastructure 200. In an embodiment, access control lists (ACLs) may be applied to a range of static addresses to segregate one customer's traffic from another or to enable and disable ancillary services for particular customers.

In an embodiment, the DNA server 250 uses ACLs to control access to certain services and/or addresses for customer(s). ACLs may be applied to a known range of static addresses rather than random dynamic addresses. ACLs allow the DNA server 250 to control crosstalk between customers so one customer may not access another customer's devices, for example. ACLs allow the DNA server 250 to limit a customer's access to additional fee-based services, such as Internet access, device wake-up, etc. Thus, feature-based revenue may be protected.

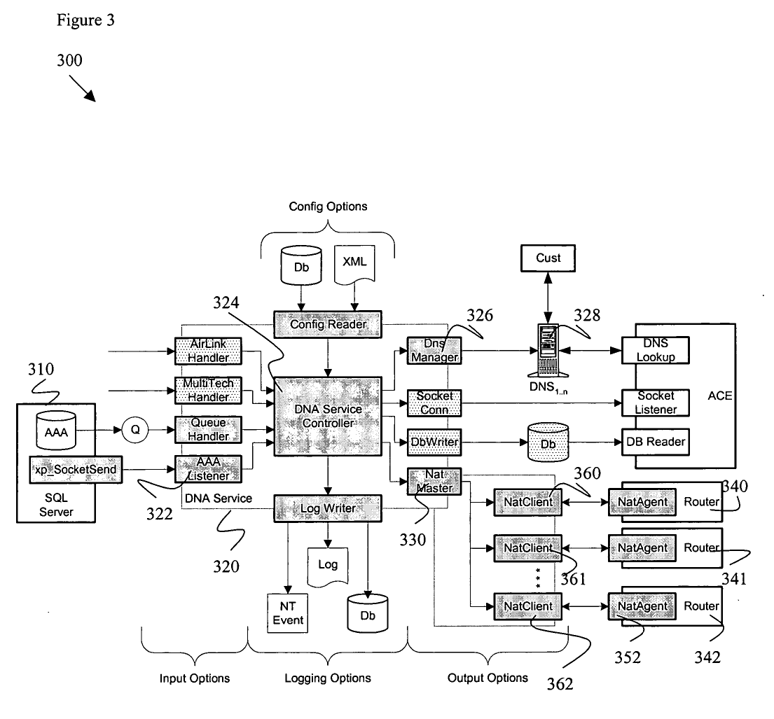

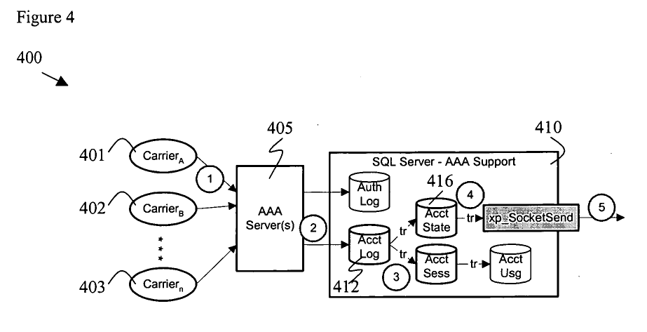

FIG. 3 illustrates a DNA service architecture 300 used in accordance with an embodiment of the present invention. As shown in FIG. 3, information from carriers is forwarded to the DNA service controller 350 which distributes address mapping commands to the custom NAT routers 380-382. Each section of the DNA service architecture 300 is explained further with respect to FIGS. 4-7 below.

FIG. 4 illustrates an access radius operation forwarding system 310 used in accordance with an embodiment of the present invention. Carrier networks 401-403 send authentication and accounting records to AAA server(s) 405. The AAA server(s) 405 are configured to forward authentication and accounting log entries to an AAA support database 410, such as an SQL (Structured Query Language) database.

Accounting records are stored in the Accounting Log table 412. An After-Insert trigger on the Accounting Log table 412 maintains entries in the Accounting State table 416. The Accounting State table 416 contains one record per device. The Accounting State table 416 keeps track of the latest device information including status and dynamic carrier IP address, for example. In an embodiment, device records may be used and/or modified without storage in the tables 412, 416. For example, accounting data may be accepted from a carrier and processed without storing the information in a database or table.

An On-Modify trigger or indicator on the Accounting State table 416 calls or executes a procedure or function (e.g., sp_HandleRadiusOp) when a state (e.g., Stop, Start) or IP address change is detected. The procedure forwards the device change information to the DNA Service via a TCP (Transmission Control Protocol) socket call or other transport medium, for example. In an embodiment, record information may be passed to the DNA service without storage in the Accounting Log table 412 and/or Accounting State table 416.

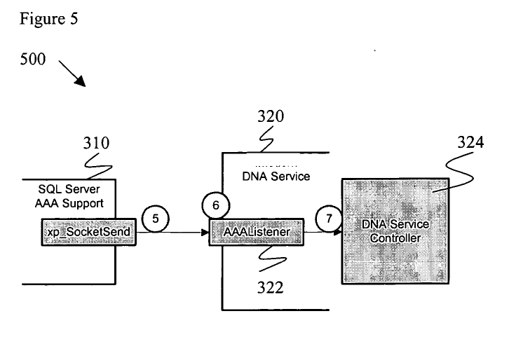

FIG. 5 illustrates components of a DNA service 320. FIG. 5 illustrates an access listener system 500 used in accordance with an embodiment of the present invention. The AAA Listener component 322 accepts TCP packets on a specific port. The TCP packet is converted to an object (e.g., a RadiusOp object), which is analyzed for proper format (e.g., iMS:RadiusOp format). The object is then forwarded to the DNA Service Controller 324.

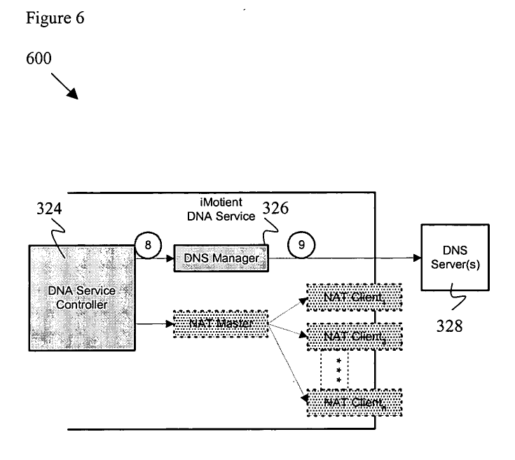

FIG. 6 illustrates a DNS manager system 600 used in accordance with an embodiment of the present invention. In an embodiment, the DNA Service Controller 324 sends a copy of the object to the DNS Manager 326. The DNS Manager component 326 sends dynamic DNS updates to the configured DNS server(s) 328.

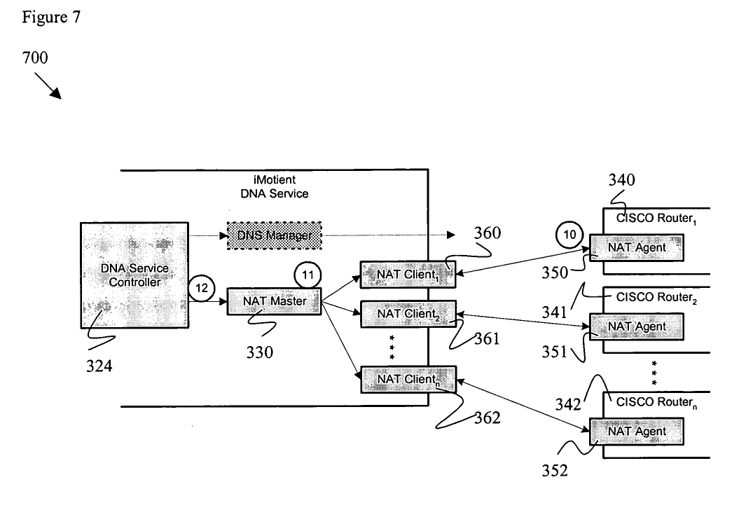

FIG. 7 illustrates a NAT master system 700 used in accordance with an embodiment of the present invention. Each NAT router 340-342 runs a “NAT Agent” application 350-352, such as a tool command language (TCL) application. In an embodiment, each NAT router 340-342 executes a custom NAT Agent TCL application 350-352. The NAT Agent 350-352 is configured to look for one or more DNA services. When found, the NAT Agent 350-352 calls the DNA Service's NAT Master 330. The NAT Master 330 then creates a new NAT Client 360-362 to handle all communication with that router 340-342. One NAT Agent 350-352 is created for each router 340-342 that calls in.

The NAT Client 360-362 authenticates the router 340-342 then fetches the router's “as-is” network address translation table currently stored in the router. The NAT Client 360-362 retrieves the “should-be” network address translation list from the AAA database 410 and synchronizes the router's NAT list with the AAA's NAT list. Once the NAT lists have been synchronized, the router 340-342 is placed on-line. After the router 340-342 is on-line, the DNA Service controller 324 forwards commands to the NAT Master 330 for distribution to the router 340-342. In an embodiment, only commands that contain dynamic to Static IP translations are forwarded to the NAT Master 330. The NAT Clients 360-362 handle all NAT Add, Delete, and Re-Plant operations, for example.

In an embodiment, device identification and/or address information may be used to configure or “seed” the DNS server. That is, the DNA system adds and/or removes records from the DNS so that static IP addresses may be retrieved from the DNS server rather than from the router. In addition, authorized customers may be able to access the DNS server and lookup static addresses by phone number or other device identifier, for example. In an embodiment, a DNS entry may be used to determine whether a particular device is on the network. That is, if a device is not currently connected to the network, then the DNS entry for the device will not be available. Thus, access or presence of a device on the network may be identified.

In an embodiment, the DNA system may include a “wake-up” or device activation mechanism. For example, if a static address assigned to a device is not active (e.g., the router or DNS has no address translation available for the device), a message may be sent to the device to activate or connect the device to the network. For example, a packet may be sent to another server to transmit a short message service (SMS) message to the device to bring the device back on line.

In an embodiment, the address mapping table includes a plurality of device identifiers and static addresses assigned to those identifiers. In an embodiment, blocks of static addresses may be allocated to different customers. For example, when a carrier or other customer registers with the DNA system, the customer is assigned a certain block of available static addresses. When a device from a particular carrier or customer registers, it is assigned a static address from that customer's block. Thus, a customer may be informed regarding which static addresses are assigned to which of its devices. In an embodiment, multiple devices may be mapped to a single static address or group of static addresses. Conversely, multiple static addresses may be mapped to a single device or group of devices. Additionally, security may be provided using static addresses or address blocks. For example, customers may be prevented from communicating to other devices outside of their static address range.

In an embodiment, the DNA router includes a route injector. The route injector receives subnets or network blocks used by the DNA system. The route injector establishes the subnets such that the subnets and addresses appear to be valid to external systems. For example, traffic from host servers will be properly routed to the DNA router whether or not the customer's specific static addresses are mapped. When a packet arrives, the DNA router translates mapped packets and forwards them on to the carrier.

In an embodiment, packets destined for unmapped addresses are dropped, preventing delivery of illegitimate traffic to the carrier. For example, route injectors may prevent illegitimate traffic from traversing from customers to a carrier if the recipient device is not on-line. If the device is not on-line, route injectors gather the illegitimate packets from host connections and delete or discard the packets such that the packets are not delivered. For example, if two customers are sharing a set of dynamic addresses and data is transmitted for the first customer while the second customer is using a common dynamic address, the data may be dropped rather than unintentionally delivered to the second customer. Alternatively, the system may attempt to “wake up” an intended device recipient, as described above.

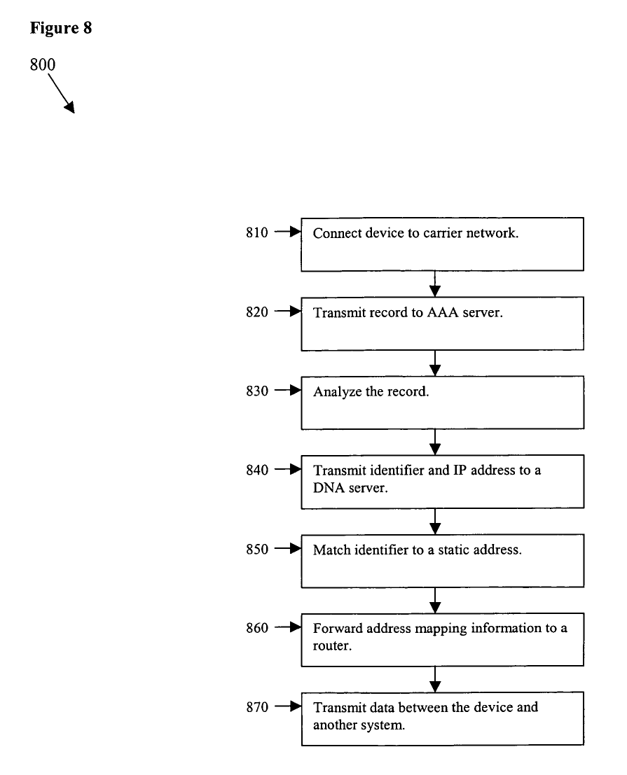

FIG. 8 depicts a flow diagram for a method 800 for dynamic network architecture used in accordance with an embodiment of the present invention. First, at step 810, a wireless device connects to a carrier network. In an embodiment, the device may be authenticated to allow access to the carrier network and/or to particular functionality or resources in the carrier network. Then, at step 820, an accounting record, such as a session “start” record, is transmitted to an AAA server or other access server. For example, an accounting record generated by a carrier infrastructure is transmitted to an accounting server indicating that a mobile device is using the network. Next, at step 830, the record is analyzed. In an embodiment, the record includes an identifier for the device, such as a tracking number, routing number or other identifier. The record also includes an address that is currently assigned to the device. The record may be stored in a database or log, for example.

At step 840, the device identifier and IP address are transmitted to a DNA server. Then, at step 850, the identifier is matched to a static address. For example, a database or table including a list of device identifiers and corresponding static IP addresses is searched to locate the device identifier. The corresponding static address associated with the identifier is then retrieved from the list.

At step 860, information regarding address mapping is forwarded to a NAT router. For example, the dynamic address and static address for the device are forwarded to the router. An address translation is implemented at the router such that data arriving for the device at the device's static address is routed to the dynamic address assigned to the device, and data transmitted from the device at the device's dynamic address is sent from the static address assigned to the device. Then, at step 870, data may be transmitted to and from the device and another system.

In an embodiment, the device may be addressed at its static address and/or its dynamic address by an external system. The router may match the static or dynamic address to the device for transmission of data. In an embodiment, the device may communicate with an external system over a plurality of networks, such as a terrestrial network, a satellite network, and the like.

Thus, certain embodiments provide a system and method using accounting records from mobile carrier networks to manage automatic mapping of dynamic addresses to a constant well-known static address for mobile devices. Certain embodiments provide a system and method outside a carrier infrastructure that manages static translations for host machines without the knowledge of the carrier or a host. That is, the device, carrier and external host system may operate normally with a transparent address translation facilitating communication among the systems. The system and method may facilitate communication and address translation in a wireless network and/or any other IP-based network that supports AAA forwarding, for example. Certain embodiments of the systems and methods may be implemented as one or more sets of instructions on an electronically-readable medium capable of execution on a processor, such as a computer or other processor.

Carrier networks transmit accounting records that contain a mobile device's dynamic address assigned by the carrier. A ‘start’ record is received when the mobile device starts a wireless session, and a ‘stop’ record is received when the device stops a session. The same device may acquire a different dynamic address at each ‘start’ and be assigned a static address. Information included in the carrier's start and stop records is used to inject commands into a router that maps the carrier's dynamic address to a known static address.

Certain embodiments allow carrier address pools to be translated to a distinct address range for each customer. The range may be customized to best fit the customer's network requirements. In an embodiment, a customer may not even know what the carrier addresses are. Certain embodiments provide customers with one route for traffic for any device on any supported network. Devices from an additional carrier may be added without changing the customer's routes. Additionally, certain embodiments allocate specific blocks of addresses to specific customers. Translation of carrier addresses to specific blocks for each customer allows the system to prevent unauthorized crosstalk.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for address translation in a mobile network, wherein the network includes a device associated with an identifier and assigned a dynamic address, said method comprising:
matching the identifier for the device to a static address;
creating an address mapping between the dynamic address assigned to the device and the static address; and
transmitting data to and from the device using the address mapping.

2. The method of claim 1, further comprising transmitting a record indicating a presence of the device on the network, wherein the record includes the identifier for the device.

3. The method of claim 1, further comprising providing the address mapping to a router for routing data between the device and another entity.

4. The method of claim 1, wherein said creating step further comprises automatically creating an address mapping between the dynamic address and the static address.

5. The method of claim 1, wherein the static address is a known address assigned to the device.

6. The method of claim 1, further comprising allocating a pool of static addresses to a carrier for mapping dynamic addresses for devices from the carrier to static addresses from the pool of static addresses.

7. The method of claim 1, further comprising seeding a domain name system using the address mapping.

8. The method of claim 1, further comprising activating the device in response to data being transmitted to the device using the address mapping.

9. A system for address mapping in a network, said system comprising:
a dynamic network address (DNA) server, wherein said DNA server is configured to map a dynamic address to a static address based on a device identifier associated with the dynamic address; and
a router for routing data in the network, wherein said router is configured to route data using the mapping between the static address and the dynamic address.

10. The system of claim 9, further comprising a record including the device identifier and the dynamic address associated with the device identifier.

11. The system of claim 10, further comprising a database storing said record.

12. The system of claim 9, further comprising a domain name system (DNS) providing address mapping for one or more devices, wherein said DNS is seeded using said mapping between the static address and the dynamic address.

13. The system of claim 9, wherein said router includes a network address translation (NAT) mapping the dynamic address to the static address for the device identifier.

14. The system of claim 9, wherein said router includes an access control list to regulate traffic for a range of static addresses.

15. The system of claim 9, wherein said DNA server allocates a block of static addresses to a carrier for mapping dynamic addresses for devices from the carrier to static addresses from the block of static addresses.

16. The system of claim 9, further comprising a route injector configured to establish a subnet and address based on said mapping to receive data from an external system.

17. An electronically-readable storage medium including a set of instructions for a processor, said set of instructions comprising:
an accounting routine for receiving an accounting record for a device, wherein the accounting record includes a dynamic address allocated to the device;
a mapping routine for mapping the dynamic address to a static address assigned to the device; and
a routing routine for routing data to and from the device using the address mapping.

18. The set of instructions of claim 17, wherein said mapping routine automatically maps the dynamic address to the static address assigned to the device upon receipt of the accounting record and wherein said routing routine automatically routes data to and from the device using the address mapping.

19. The set of instructions of claim 17, wherein said mapping routine matches a device identifier associated with the device to a corresponding static address assigned to the device and maps the dynamic address to the static address.

20. The set of instructions of claim 17, wherein said routing routine regulates data transmitted to and from the device using the address mapping based on a criterion, wherein the criterion includes at least one of an authorization, a device activation, and an address range.

21. The set of instructions of claim 17, wherein said dynamic address comprises a dynamic internet protocol (IP) address.

22. A device including an electronically-readable storage medium having a set of instructions for execution on a processor, wherein said set of instructions comprises:
an accounting routine for receiving an accounting record for a device, wherein the accounting record includes a dynamic address allocated to the device;
a mapping routine for mapping the dynamic address to a static address assigned to the device; and
a routing routine for routing data to and from the device using the address mapping.

23. The set of instructions of claim 22, wherein said mapping routine matches a device identifier associated with the device to a corresponding static address assigned to the device and maps the dynamic address to the static address.
